(19) United States
(12) Patent Application Publication
(10) Pub. No.: US 2025/0168504 A1
(43) Pub. Date: May 22, 2025

(54) IMAGE PROCESSING APPARATUS, IMAGE CAPTURING APPARATUS, OBJECT SIZE DETERMINATION METHOD, AND STORAGE MEDIUM

(71) Applicant: CANON KABUSHIKI KAISHA, Tokyo (JP)

(72) Inventor: YASUHIRO MATSUO, Tokyo (JP)

(21) Appl. No.: 18/939,794

(22) Filed: Nov. 7, 2024

(30) Foreign Application Priority Data
Nov. 21, 2023 (JP) 2023-197587

(51) Int. Cl. H04N 23/67; G06T 7/62; G06T 7/70; H04N 23/61

(52) U.S. Cl. CPC H04N 23/67; G06T 7/62; G06T 7/70; H04N 23/61

(57) ABSTRACT

An image processing apparatus comprises a selection unit that selects an object to be detected; an acquisition unit that acquires an image; a detection unit that detects the object selected by the selection unit from the image; and a determination unit that determines a size of the object detected by the detection unit in the image, wherein the determination unit changes part of the object to be determined as the size of the object in the image in accordance with a shape of the object.

### BACKGROUND OF THE INVENTION

### Field of the Invention

The present invention relates to image processing apparatus, image capturing apparatus, object size determination method, and storage medium, and in particular, to techniques for identifying the size of an object in an image.

### Description of the Related Art

In conventional autofocus control of a camera, one main subject is selected from a plurality of people, and focus control is performed by following the main subject to keep it in focus. In particular, in sports using a ball, the player keeping the ball tends to be the main subject, so a method of selecting the main subject based on the detection information of a ball has been disclosed. For example, Japanese Patent Laid-Open No. 2018-66889 employs a method of detecting a ball in a captured image and selecting a person who is close to the detected ball on the screen.

However, in a scene where a plurality of people are standing near and far from the camera in the direction of the optical axis (z-axis) and the ball exists in the middle of the people, it is difficult to determine which person is actually near the ball based only on the information on the screen (xy-plane). Under such circumstances, it is effective to compare the size of the ball on the screen with the sizes of the people's heads and select a person closer to the ball as the main subject by taking into account the positions of the ball and the people in the optical axis (z-axis) direction of the camera using the comparison results. Therefore, it is desirable to improve the accuracy of not only the detection of the ball but also the measurement of the size of the ball on the screen.

There are two factors that make it difficult to measure ball size in ball sports: The first factor is the measurement of ball size in sports that use an inflated oval ball. For example, American football and rugby use an inflated oval ball. The shape of an inflated oval ball changes depending on the angle from which the ball is viewed, even if it exists at the same distance from the camera in the direction of the optical axis (z-axis) of the camera. Therefore, depending on the angle of the ball, it can look bigger or smaller on the screen. The same thing can happen with objects other than balls, such as Frisbees, whose shape changes depending on the angle from which they are viewed.

The second factor is the measurement of ball size in scenes where the ball is occluded. For example, in American football, rugby, basketball, and other sports where players tend to hold the ball, the ball is easily hidden, making ball detection itself difficult before ball size measurement.

### SUMMARY OF THE INVENTION

The present invention has been made in consideration of the above situation, and allows the size of an object in an image to be stably identified according to the object's shape.

According to the present invention, provided is an image processing apparatus comprising one or more processors and/or circuitry which function as: a selection unit that selects an object to be detected; an acquisition unit that acquires an image; a detection unit that detects the object selected by the selection unit from the image; and a determination unit that determines a size of the object detected by the detection unit in the image, wherein the determination unit changes part of the object to be determined as the size of the object in the image in accordance with a shape of the object.

Further, according to the present invention, provided is an image capturing apparatus comprising: an image processing apparatus comprising one or more processors and/or circuitry which function as: a selection unit that selects an object to be detected; an acquisition unit that acquires an image; a detection unit that detects the object selected by the selection unit from the image; and a determination unit that determines a size of the object detected by the detection unit in the image; and an image sensor that captures an image, wherein the determination unit changes part of the object to be determined as the size of the object in the image in accordance with a shape of the object, and the acquisition unit acquires the image captured by the image sensor.

Furthermore, according to the present invention, provided is an image capturing apparatus comprising: an image processing apparatus comprising one or more processors and/or circuitry which function as: a selection unit that selects an object to be detected; an acquisition unit that acquires an image; a detection unit that detects the object selected by the selection unit from the image and a position of the detected object in the image; a determination unit that determines a size of the object detected by the detection unit in the image; and a subject detection unit that detects a predetermined subject included in the image and obtains the position and size of the detected subject in the image, and a decision unit that decides, in a case where a plurality of the subjects are detected by the subject detection unit, a main subject from the plurality of subjects based on the position and size of each of the subjects in the image and the position and size of the object in the image; and a focus control unit that performs focus control so as to focus on the main subject decided by the decision unit, wherein the determination unit changes part of the object to be determined as the size of the object in the image in accordance with a shape of the object.

Further, according to the present invention, provided is an object size determination method comprising: selecting an object to be detected; acquiring an image; detecting the selected object from the image; and determining a size of the detected object in the image, wherein part of the object to be determined as the size of the object in the image is changed in accordance with a shape of the object.

Further, according to the present invention, provided is a non-transitory computer-readable storage medium, the storage medium storing a program that is executable by the computer, wherein the program includes program code for causing the computer to function as an image processing apparatus comprising: a selection unit that selects an object to be detected; an acquisition unit that acquires an image; a detection unit that detects the object selected by the selection unit from the image; and a determination unit that determines a size of the object detected by the detection unit in the image, wherein the determination unit changes part of the object to be determined as the size of the object in the image in accordance with a shape of the object.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating a functional configuration of an image capturing apparatus according to a first embodiment of the present invention.

FIGS. 2A and 2B are diagrams showing an example of a user interface for selecting an object according to an embodiment.

FIG. 3 is a flowchart of focus control processing according to the embodiment.

FIG. 4 is a flowchart of object size determination processing according to the first embodiment.

FIGS. 5A to 5E are explanatory diagrams of determining the size of an inflated oval ball according to the first embodiment.

FIGS. 6A to 6D are explanatory diagrams of the effects of the first embodiment.

FIG. 7 is a block diagram illustrating a functional configuration of an image capturing apparatus according to a second embodiment.

FIG. 8 is a flowchart of object size determination processing including a case where an object is occluded according to the second embodiment.

FIGS. 9A and 9B are explanatory diagrams of a method for detecting an occluded ball according to the second embodiment.

FIG. 10 is a flowchart of spherical ball size determination processing in a ball game in which a ball is occluded at high probability according to the second embodiment.

FIG. 11 is an explanatory diagram of a method for detecting an occluded inflated oval ball according to the second embodiment.

FIG. 12 is a flowchart of inflated oval ball size determination processing in a ball game in which a ball is occluded at high probability according to the second embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

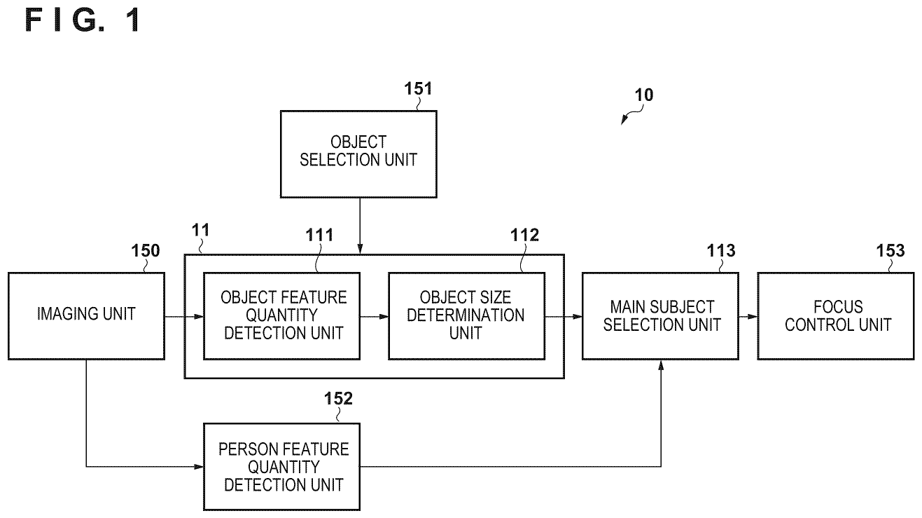

FIG. 1 is a block diagram illustrating a functional configuration of an image capturing apparatus 10 as a configuration with an image processing apparatus including an object detection unit 11 that detects an object and determines the size of the object from an image obtained by shooting according to a first embodiment of the invention.

The image capturing apparatus 10 has an imaging unit 150, an object selection unit 151, the object detection unit 11, a person feature quantity detection unit 152, a main subject selection unit 113, and a focus control unit 153. The object detection unit 11 includes an object feature quantity detection unit 111 and an object size determination unit 112.

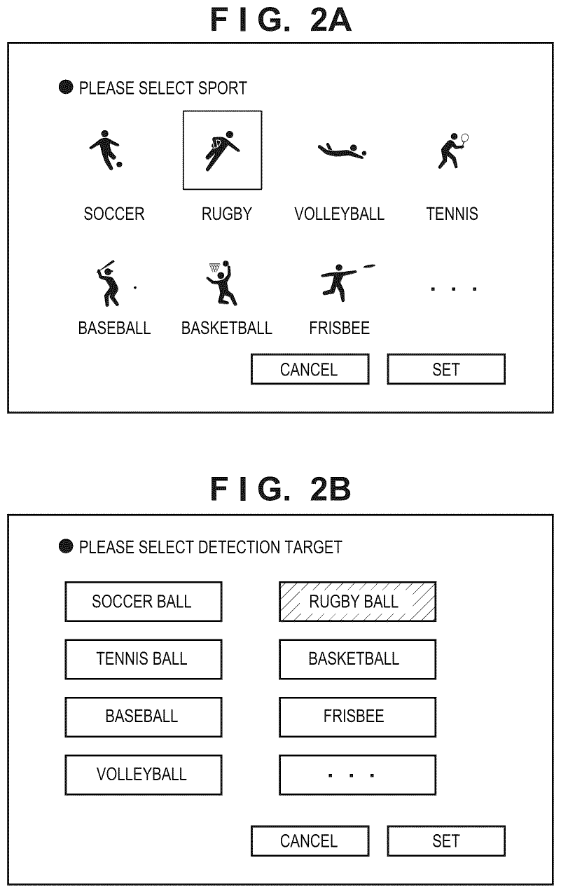

A user uses the object selection unit 151 to select an object to be detected from a still or moving image obtained by the imaging unit 150. FIGS. 2A and 2B show an example of a user interface displayed on the display unit in a case where the object selection unit 151 is configured with an display unit and an operating unit such as a touch panel or directional buttons. The user can select from the choices displayed on the display unit by operating the operating unit such as the touch panel and directional buttons. The examples shown here are for selecting a sport (FIG. 2A) and for directly selecting an object to be detected (FIG. 2B). If the type of sport is selected, the sport and the object to be detected (e.g., a ball or other tool used in the selected sports) are associated in advance, and the object associated with the selected sport is set as the target of detection. The sports and objects to be selected are not limited to those shown in FIGS. 2A and 2B, and the way the choices are displayed is not limited to those shown in FIGS. 2A and 2B.

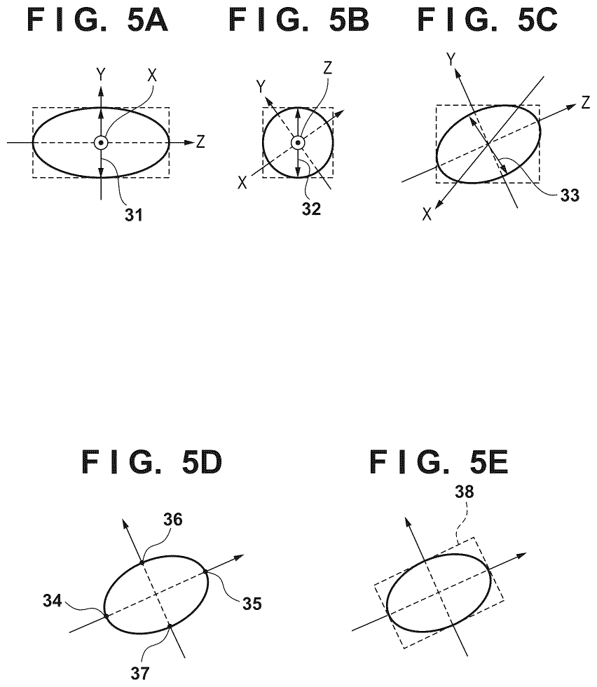

The object feature quantity detection unit 111 detects a selected object (e.g., a ball) from a still or moving image obtained by the imaging unit 150 based on the selection by the object selection unit 151, and obtains the feature quantities of the detected object (hereinafter referred to as “object feature quantities”). The object feature quantities are described below with reference to FIG. 5A to FIG. 5E. The object size determination unit 112 measures the detected object in the image and determines the final object size (hereinafter referred to as “object size”) based on the obtained values.

The person feature quantity detection unit 152 detects a person from a still or moving image obtained by the imaging unit 150 and obtains feature quantities of the detected person (hereinafter referred to as “person feature quantities”). As the person feature quantities, the position (xy-coordinates) and size of a body part, such as the head, on the image (xy-plane) are obtained. The person feature quantities may be information that can be used to determine where the main subject is located in the image at the time of performing focus control, as described below.

The main subject selection unit 113 selects one of the body parts detected by the person feature quantity detection unit 152 as the main subject based on the xy-coordinates and sizes of the detected body parts and the xy-coordinates and object size of the detected object. The focus control unit 153 performs focus control so that the main subject is in focus based on the xy-coordinates of the body part of the main subject selected by the main subject selection unit 113.

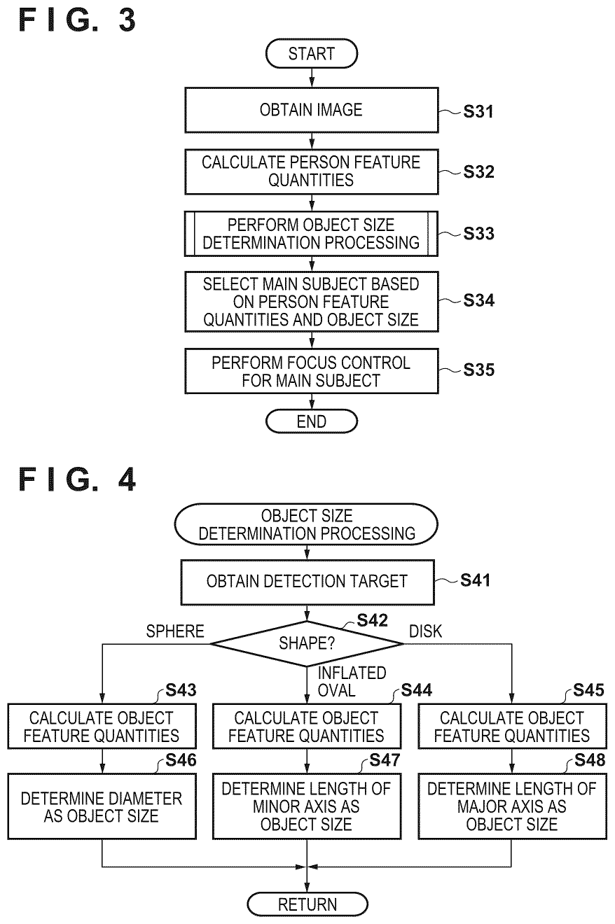

FIG. 3 is a flowchart showing the focus control processing to focus on the main subject in the embodiment.

First, in step S31, an image is acquired by the imaging unit 150. In the case of capturing a moving image with the imaging unit 150, a frame image extracted from the moving image is acquired. Next, in step S32, the person feature quantity detection unit 152 detects a person or persons in the image acquired in step S31, and calculates the person feature quantities of the detected person or persons.

In step S33, selected using the object selection unit 151 performs object size determination processing of detecting an object from the image acquired in step S31, and identifying the position (xy coordinate) of the detected object on the image (xy-plane) and the object size. The details of the object size determination processing are described below with reference to FIG. 4.

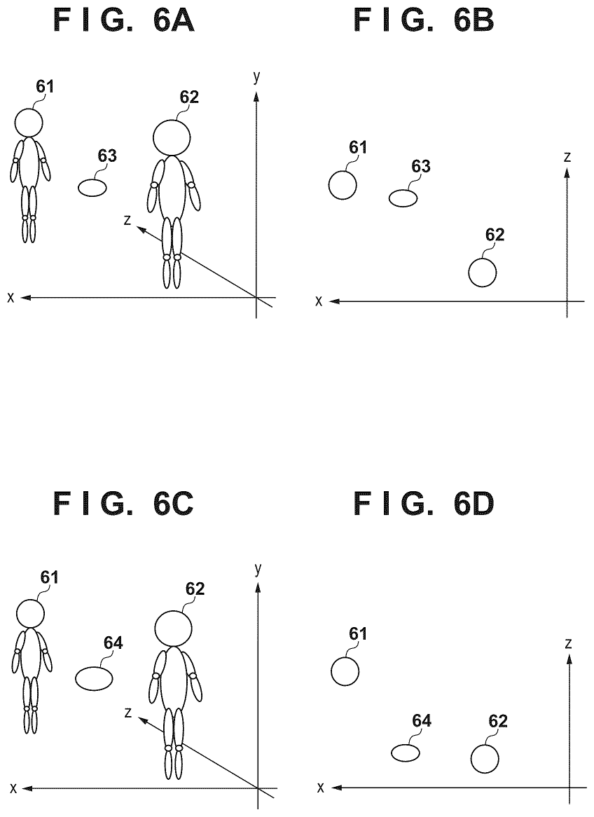

In step S34, the main subject selection unit 113 performs main subject determination based on the person feature quantities and the xy-coordinates and size of the object, and in step S35, focus control is performed so that the main subject selected in step S34 is in focus. The main subject determination based on the person feature quantities and the xy-coordinates and size of the object performed in step S34 is described below with reference to FIGS. 6A to 6D.

Next, refer to FIG. 4 to explain the object size determination processing in step S33.

First, in step S41, the detection target selected by the object selection unit 151 is acquired, and the object feature quantity detection unit 111 determines the shape of the object to be detected. If the shape of the object to be detected is, for example, a sphere such as a soccer ball, baseball, tennis ball, basketball, etc., then the process proceeds to step S43. If the shape of the object to be detected is, for example, an inflated oval shape such as a rugby ball, a ball used in American football, etc., the process proceeds to step S44. If the shape of the object to be detected is, for example, a disc such as a Frisbee, the process proceeds to step S45.

In step S43, the object feature quantity detection unit 111 detects an object to be detected from the image acquired in step S31, and obtains object feature quantities of the detected object. The object feature quantities are obtained by a neural network and include the position of the object on the image (xy-plane) and object feature points for identifying the object size, as described below. Here, since the shape of the object to be detected is a sphere, in step S46, the object size determination unit 112 calculates the diameter of the object on the image (xy-plane) from the object feature points and determines the calculated diameter as the object size.

In step S44, the object feature quantity detection unit 111 detects an object to be detected from the image acquired in step S31 as in step S43, and calculates the object feature quantities of the detected object. If the shape of the object to be detected is an inflated oval shape, in step S47, the object size determination unit 112 obtains the length of the minor axis of the object based on the object feature points, and determines the obtained length of the minor axis as the object size. The reason why the length of the minor axis is determined as the object size and the method for determining the length of the minor axis are described below.

In step S45, the object feature detecting unit 111 detects an object to be detected from the image acquired in step S31 as in step S43, and calculates the object feature quantities of the detected object. If the shape of the object to be detected is disk, in step S48, the object size determination unit 112 obtains the length of the major axis of the object based on the object feature points and determines the obtained length of the major axis as the object size. The reason why the length of the major axis is determined as the object size and the method for determining the length of the major axis are described below.

After the object size determination is completed by one of steps S46, S47, and S48, the process returns to the process in FIG. 3.

The reason for determining the length of the minor axis of a ball having an inflated oval shape as the object size is explained here.

FIGS. 5A to 5C show the shape of an inflated oval ball viewed from different angles. On the ball shown in FIGS. 5A to 5C, the x-, y-, and z-axes fixed to the ball are shown. Here, the z-axis direction corresponds to the axis along which the length of the ball is the longest, and the x- and y-axis directions correspond to the axes along which the length of the ball is the shortest. FIG. 5A shows the case where the z-axis extends in the direction of the width of the drawing, FIG. 5B shows the case where the z-axis extends from the back to the front of the drawing, and FIG. 5C shows the case where the z-axis is slightly tilted toward the front of the drawing.

As shown by the dotted rectangular region in FIGS. 5A to 5C, the rectangular region surrounding an inflated oval ball changes depending on the angle of the ball. Therefore, if the area where the ball exists is detected by a rectangular region and the ball size is estimated from the rectangular region, the estimated ball size is not stable.

Here, the lengths of the minor axis in FIGS. 5A to 5C are indicated by 31, 32, and 33, respectively. In FIG. 5A, the ball size in the direction along the y-axis corresponds to the length of the minor axis. In FIG. 5B, the length of the minor axis of the ball size is defined in the vertical direction of the drawing, but not limited to this case. In FIG. 5C, the ball is looked down from the direction of the longest length of the lengths of the three-dimensional inflated oval ball, resulting in that the shape of the ball approaches a circular shape.

The point to be noted here is that when the inflated oval ball is viewed from various angles as described above, the lengths of the short axes 31, 32, and 33 of the elliptical region projected onto the screen are almost the same. If the size in the direction orthogonal to the minor axis were defined as the length of the major axis, the length of the major axis may appear longer or shorter depending on the angle of the ball. Therefore, by noting that the length of the minor axis of an inflated oval shape when projected onto a screen remains almost constant regardless of the angle from which it is viewed, the ball size (object size) is determined by the length of the minor axis. This makes it possible to stably determine the object size regardless of the orientation of the ball.

Next, the method for measuring the length of the minor axis of an inflated oval shape is described.

First, the object feature quantity detection unit 111 uses a general object detection method using a neural network to detect the object to be detected, which is selected by the object selection unit 151 from the obtained image. FIGS. 5A to 5C show the method of detecting a rectangular region where an inflated oval ball exists, as shown by the dotted rectangular region. As the method for detecting rectangular regions as shown in FIGS. 5A to 5C, rectangular regions surrounding various objects to be detected (in this case, balls) are prepared in advance as training data for learning, and the neural network is trained. As the training data for learning, information of rectangular regions each surrounds the entire object (ball) is prepared. At this time, if there is an image in which a part of the object is occluded, the image with the object which is occluded by a large portion is not used for learning as invalid data, and the image in which the object is not occluded is used for learning.

The learning is carried out so as to achieve ability of inferring a total of three maps: a center map for inferring the center position of the ball, and two size maps for inferring the vertical and horizontal sizes of a rectangular region surrounding the entire ball. By learning in this way, the rectangular region can be inferred from the center position of the ball, the vertical size and the horizontal size of the rectangular region surrounding the entire ball.

Next, two methods for detecting object feature quantities for measuring the length of the minor axis of an inflated oval shape and measuring the length of the minor axis based on the detected object feature quantities will be described.

In the first method, endpoints in the direction of the minor axis are detected as object feature quantities, the length between the two endpoints is measured, and the measured length of the minor axis is determined as the object size. In FIG. 5D, a total of four endpoints are shown by black dots on an ellipse with endpoints 34 and 35 in the direction of the major axis and endpoints 36 and 37 in the direction of the minor axis. The object feature quantity detection unit 111 detects the endpoints in the minor axis direction by learning the center map so that the center position between the endpoints 36 and 37 in the minor axis direction is estimated. Then, the length between those two endpoints is measured by the object size determination unit 112, and the measured length of the minor axis is adopted as the object size.

The second method uses the same detection technique that uses the rectangular region described with reference to FIGS. 5A to 5C, but instead of learning the vertical and horizontal sizes of the rectangular region surrounding the entire ball, the major and minor axis sizes of the ball are learned. In the case of FIGS. 5A to 5C, information on the rectangular regions that surround the entire ball is prepared, but a total of 4 endpoints with the endpoints 34 and 35 in the major axis direction and the endpoints 36 and 37 in the minor axis direction shown in FIG. 5D are prepared as training data for learning, and the center position, the length of the major axis and length of the minor axis of the ball are learned from these four points. This enables inference of the length of the major axis and length of the minor axis of the ball as object feature quantities. Here, the angle between one side (horizontal or vertical axis) of the image and one side (major or minor axis) of the rectangular region is not learned, but by learning and inferring the inclined angle of the rectangular region as well, it is possible to estimate the rectangular region indicated by dotted lines as shown in FIG. 5E. Then, the object size determination unit 112 adopts the estimated length of the minor axis as the object size, out of the length of the major axis and the length of the minor axis, based on the shape of the object to be detected.

Although the above two methods for determining the length of the minor axis of an object having an inflated oval shape are described above, the present invention is not limited to these methods. For example, an elliptical region may be fitted to the ball in the object feature quantity detection unit 111, and the minor axis may be estimated from the parameters of the estimated elliptical region.

In the case of detecting a disk-shaped equipment such as a Frisbee, the equipment is detected using a method similarly to that for detecting an inflated oval ball that uses a neural network.

If the object to be detected is a disk, it looks largest when the disk is viewed from above and has a circular shape, and when viewed from an angle, the length of the major axis remains the same but has a collapsed oval shape. In this case, the length of the major axis of the image of the object is always constant, while the length of the minor axis varies. Therefore, for disk-shaped objects such as Frisbees, by using the length of the major axis, it is possible to achieve stable size estimation.

Next, the main subject determination using object size detected by the method described above and the effect of stable detection of object size on autofocus control is described.

In the autofocus control of a camera, one main subject is selected from among a plurality of people and the focus is set on the main subject. In particular, in sports using a ball, a player close to the ball tends to be the main subject, so a method of selecting the main subject based on detection information of a ball has been disclosed.

In a scene where a plurality of people stand near and far from the camera in the direction of the optical axis (z-axis) of the camera and a ball exists in the middle of the people, it is difficult to determine which person will be the main subject based only on the information of the positional relationship between the ball and the people on the image (xy-plane). In such a situation, it is effective to select the person closest to the ball in the optical axis (z-axis) direction of the camera as the main subject by considering the size of the ball on the image (xy-plane) and the size of the people's heads on the image (xy-plane). Therefore, it is desirable to determine not only the position of the ball but also the size of the ball at high accuracy.

Examples of scenes in which the selection performance of the main subject is improved by improving the accuracy of ball size determination are shown in FIGS. 6A to 6D.

FIGS. 6A to 6D show the cases where a player 61 is present at the back of the screen and a player 61 is present at the front of the screen in the optical axis (z-axis) direction of the camera. FIGS. 6A and 6C show the cases where the players and the ball are viewed from the front where the camera is present, while FIGS. 6B and 6D show the cases where the players and the ball are viewed from above. Further, FIGS. 6A and 6B show the case where a ball 63 is close to the player 61, while FIGS. 6C and 6D show the case where a ball 64 is close to the player 62.

From the positioning of the player 61, player 62, ball 63, and ball 64 in the images shown in FIGS. 6A and 6B, it is not clear whether the ball 63 and the ball 64 are closer to the player 61 or player 62. However, as shown in FIGS. 6B and 6D, the actual sizes of the balls 63 and 64 are the same, but in FIGS. 6A and 6C, the ball sizes appear different because the distances to the balls in the optical axis (z-axis) direction of the camera are different. In FIG. 6A, the size of the ball 63 in the image appears smaller because the ball 63 is located farther from the camera. On the other hand, in FIG. 6C, the size of the ball 64 in the image appears larger because the ball 64 is located closer to the camera. In addition to the ball, the head of the player 61 is located farther from the camera, so the head size of the player 61 appears smaller in the image. On the other hand, the head of the player 62 is located closer to the camera, so the head size of the player 62 appears larger in the image.

Thus, since the ball size and head size in the image change according to the distance to the ball and the head of the person in the optical axis (z-axis) direction of the camera, the distance to the subject can be estimated from the size. Here, since the player closest to the ball is to be selected as the main subject, the main subject can be selected by determining whether the ball is closer to the player 61 or 62 in consideration of the ball size and head size.

If the balls 63 and 64 have an inflated oval shape, the size of the ball changes depending on the angle of the ball even if the balls 63 and 64 are at the same distance, making it difficult to determine which player is closer to the ball. Therefore, as described above, by determining the length of the minor axis as the object size for an inflated oval ball, the ball size can be determined stably, and thus the main subject can be determined stably.

In particular, if the main subject is incorrectly selected when there are people at different positions in the depth direction, as shown in FIGS. 6A to 6D, the focus will swing back and forth significantly. Therefore, by stably determining the main subject, it is possible to improve the quality of autofocusing.

As described above, according to the first embodiment, the object size can be stably determined without being affected by changes in the shape of the object to be detected due to the shooting angle.

In the first embodiment, the object size is determined for the purpose of selecting the main subject from one or more detected persons and performing focus control so that the main subject is in focus, but the purpose of the present invention is not limited to focus control. The object detection unit 11 may be used to improve the accuracy of object size determination when object size is to be measured for other purposes.

### Second Embodiment

Next, the second embodiment of the present invention will be described.

The second embodiment describes a method for stably determining object size when an object to be detected is occluded at high probability during a sport being played.

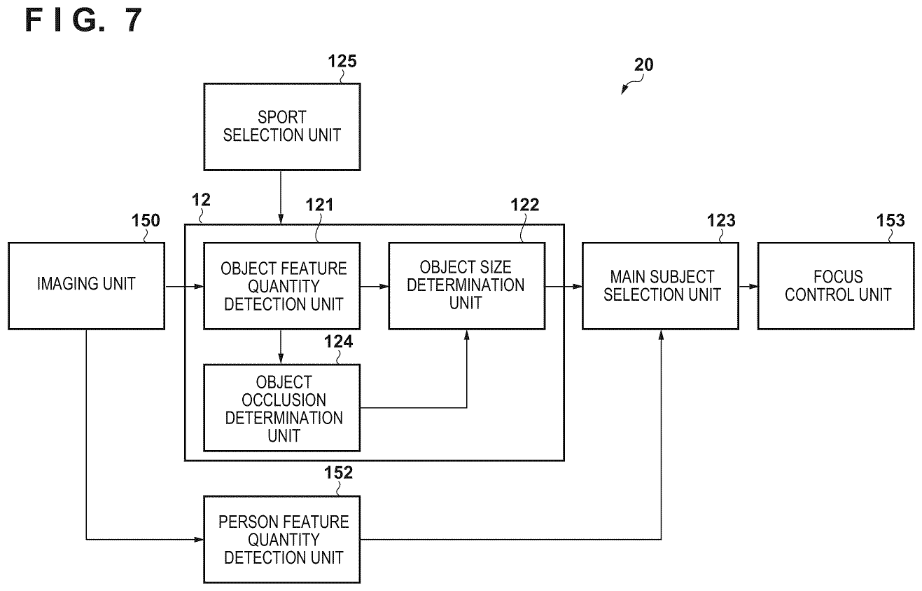

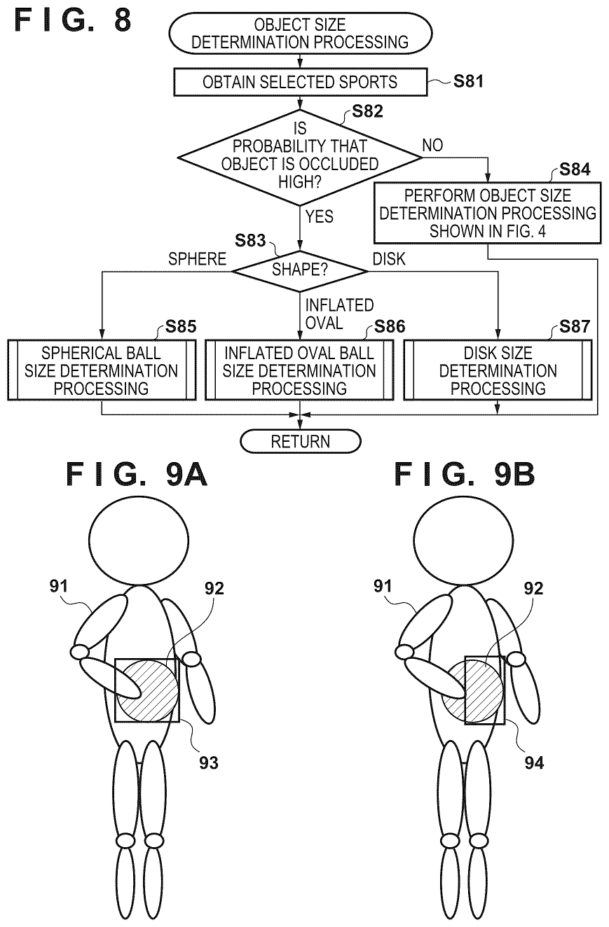

FIG. 7 is a block diagram showing the functional configuration of an image capturing apparatus 20 as a configuration including an object detection unit 12 in the second embodiment. The image capturing apparatus 20 in the second embodiment has an imaging unit 150, a sport selection unit 125, an object detection unit 12, a person feature quantity detection unit 152, a main subject selection unit 123, and a focus control unit 153. The object detection unit 12 has an object feature quantity detection unit 121, an object size determination unit 122, and an object occlusion determination unit 124. The same components as those in FIG. 1 are denoted by the same reference numerals, and detailed description thereof is omitted.

The user selects the sport to be captured by the imaging unit 150 using the sport selection unit 125. The sport selection unit 125 may have the same configuration as the object selection unit 151 and provides a user interface as shown in FIGS. 2A and 2B, for example, to determine the sport according to the selection made by the user. The sport selection unit 125 outputs information on the selected sport to the object detection unit 12.

Based on the sport selected by the sport selection unit 125, the object feature quantity detection unit 121 detects an object to be detected (e.g., a ball) used in the selected sport from a still or moving image obtained by the imaging unit 150, and detects the object feature quantities. Then, the object size determination unit 122 measures the detected object in the image and determines the object size in accordance with the sport selected by the sport selection unit 125.

Next, with reference to FIG. 8, the object size determination processing in the focus control processing in the second embodiment is explained. The focus control processing is the same as that in FIG. 3 in the first embodiment, so the explanation thereof is omitted here. In the second embodiment, the object size determination processing in step S33 is different from the processing shown in FIG. 4, so the object size determination processing is explained below.

First, in step S81, the sport selected by the sport selection unit 125 is acquired, and in step S82, it is determined whether the acquired sport is a sport in which an object to be detected is occluded at high probability during the sport is played. Whether or not the sport is one in which the object to be detected is occluded at high probability during the sport is played may be stored in advance as information on the sport. If the sport is one in which the object to be detected is occluded at low probability during the sport is played, the process proceeds to step S84 to determine the object size by the method described with reference to FIG. 4, and the process returns to the process in FIG. 3.

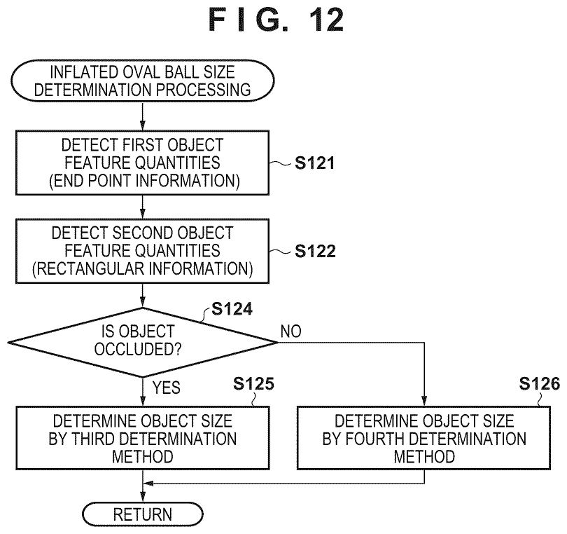

On the other hand, if the sport is one in which the object to be detected is occluded at high probability during the sport is played, the process proceeds to step S83 to determine the shape of the object to be used in the selected sport. If the shape of the object to be detected is a sphere, the process proceeds to step S85 to perform the spherical ball size determination processing shown in FIG. 10. If the shape of the object to be detected is an inflated oval shape, the process proceeds to step S86 to perform the inflated oval ball size determination processing shown in FIG. 12. If the shape of the object to be detected is a disk, the process proceeds to step S87 to perform disk size determination processing.

Once the object size determination is completed by one of steps S85, S86, and S87, the process returns to the process in FIG. 3.

Next, the spherical ball size determination processing performed in step S85 is explained with reference to FIGS. 9A and 9B and FIG. 10.

FIGS. 9A and 9B show a state in which a player 91 holds a ball 92 in the hand, and part of the ball 92 is partially occluded. FIGS. 9A and 9B show different training data preparation and detection methods. As shown in FIG. 9A, the size of the ball can be estimated by preparing the training data (frame 93) for learning that surrounds the entire ball. On the other hand, data with a large percentage of occlusion cannot be used for learning, which results in a lower detection rate for balls which are occluded for large part. Therefore, as shown in FIG. 9B, in this embodiment, only the unoccluded area of the entire ball is labeled as the training data (frame 94) for learning. In this way, the ball can be detected if it is even slightly visible, thus improving the detection rate of the ball.

FIG. 10 is a flowchart of the spherical ball size determination processing. First, in step S101, the object feature quantities are detected by the object feature quantity detection unit 121. The object feature quantities to be detected here include a rectangular region indicating the area where the ball exists. In the detection of the rectangular region in this embodiment, the data with the rectangular region assigned to the unoccluded area of the ball is used as the training data for learning when the ball is occluded as described above.

In step S103, the ball (object) occlusion determination is performed. The ball occlusion determination is performed by the object occlusion determination unit 124. In the case of a spherical ball, since the shape of the ball does not change depending on the angle from which the ball is viewed, it is possible to determine whether part of the ball is occluded by judging whether the aspect ratio of the rectangular region detected in step S101 is close to 1 or far from 1.

If it is determined in step S103 that the ball is occluded, the process proceeds to step S104, where the ball size (object size) is determined by the object size determination unit 122 using the first determination method. In this embodiment, as the first determination method, the long side of the rectangular region of the detected ball is identified as the ball size (object size). As shown in FIG. 9B, if a part of the ball is occluded, the length of the long side of the detected rectangular region is likely to be equivalent to the diameter of the spherical ball, so the length of the long side is adopted as the ball size.

On the other hand, if it is determined that the ball is not occluded in step S103, the process proceeds to step S105, and the ball size (object size) is determined by the object size determination unit 122 using the second determination method. In this embodiment, the second determination method is to obtain the average value of the long and short sides or to adopt the value of one of the long side or the short side. This is because the lengths of the long and short sides are almost the same under the condition that the ball is judged to be unoccluded, i.e., when the aspect ratio of the detected rectangular region is almost 1.

After completing the spherical ball size determination in step S104 or step S105, the process returns to the process in FIG. 8.

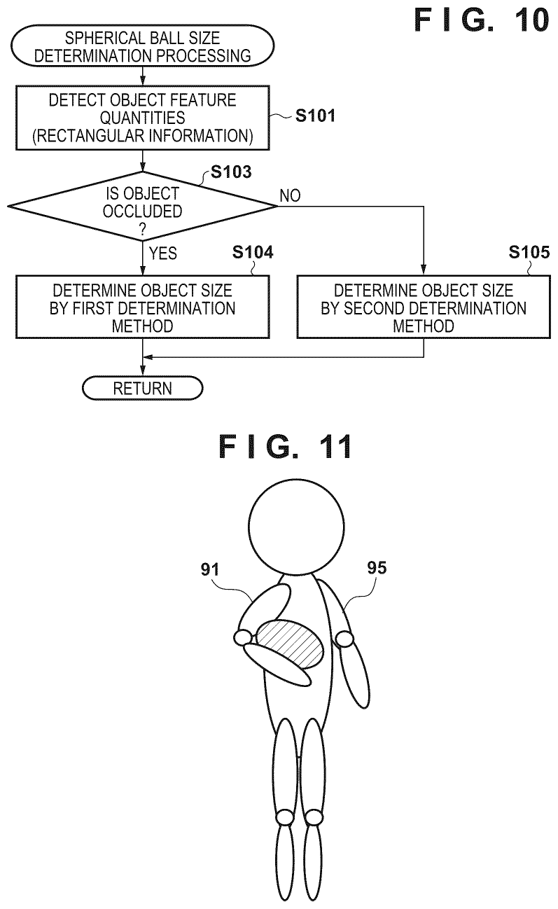

Next, the inflated oval ball size determination processing performed in step S86 is explained with reference to FIGS. 11 and 12.

FIG. 11 shows an inflated oval ball 95 partially occluded by a player 91 holding it.

FIG. 12 is a flowchart of the inflated oval ball size determination processing. First, in step S121, the first object feature quantities are detected by the object feature quantity detection unit 121. The first object feature quantities refer to a total of four points, i.e., two endpoints of the major axis and two endpoints of the minor axis described in the first embodiment.

Next, in step S122, the second object feature quantities, which are different from the first object feature quantities, are calculated by the object feature quantity detection unit 121. The second object feature quantities include a rectangular region showing the region where a ball exists. In the detection of the rectangular region in this embodiment, the data that the rectangular region is added on the unoccluded portion of the ball is used as the training data for learning. Unlike the rectangular region described in the first embodiment, by learning only the unoccluded portion, the amount of data available for learning is increased, thereby improving the detection rate even for balls that are occluded.

Next, in step S124, the ball (object) occlusion determination is performed. The ball occlusion determination is performed by the object occlusion determination unit 124. The ball occlusion determination is performed based on the endpoints of the major axis and the endpoints of the minor axis in the first object feature quantities detected in step S121. For example, if even one of the four of the endpoints of the major axis and the endpoints of the minor axis cannot be detected, the ball may be judged to be occluded. Alternatively, only two endpoints of the minor axis may be detected as the first object feature quantities, and if even one of the two endpoints of the minor axis cannot be detected, it may be determined that the object is occluded.

In addition, the method is not limited to this, and the occlusion state of the ball may be determined using person feature quantities obtained by the person feature quantity detection unit 152. For example, the person feature quantity detection unit 152 may detect a person's limbs, and if a person's limbs are detected near the ball, it may be determined that the ball is in an occluded state.

If it is determined in step S124 that the ball is occluded, the process proceeds to step S125, where the object size determination unit 122 determines the ball size (object size) by a third determination method using a rectangular region indicating the region in which the inflated oval ball exists, which is the second object feature quantities. In the third determination method, the length of the minor axis of the ball is not measured, but the ball size is determined based on the lengths of the sides of the rectangular region. For example, possible methods are to use the average of the lengths of the vertical and horizontal sides as the ball size, and to compare the ball size from one frame ago with the lengths of the vertical and horizontal sides of the rectangular region and select the closer length, but the present invention is not limited to these methods.

On the other hand, if it is determined in step S124 that the ball is not occluded, the process proceeds to step S125, and the ball size (object size) is determined by the fourth determination method by the object size determination unit 122. In this embodiment, as the fourth determination method, the length of the minor axis is adopted as the ball size based on the endpoints of the minor axis, which are the first object feature quantities.

After completing the inflated oval ball size determination in step S125 or step S126, the process returns to the process in FIG. 8.

The disk size determination process in step S87 can be performed as described using FIG. 12. In the process in step S126, the length of the major axis is adopted as the disk size (object size) based on the endpoints of the major axis among the first object feature quantities.

The effect of switching the object size determination method depending on the occluded state is explained here.

If the ball is judged to be occluded in steps S103 and S124, there is a high possibility that a person is present near the ball, and it is more likely that the main subject judgment can be made more correctly if the presence of the ball can be detected rather than by correctly estimating the ball size. Therefore, by learning only the parts of the ball that are not occluded, the ball detection rate is increased by using the results of learning that allows the ball to be detected even if it is only slightly visible.

On the other hand, if the ball is determined to be unoccluded in steps S103 and S124, there is a high possibility that the ball is present between the persons, and as explained in FIGS. 6A to 6D of the first embodiment, the accuracy of ball size estimation will likely have a significant impact on the main subject determination. Therefore, the detection accuracy of object size is increased by using the method of determining object size described in the first embodiment.

As described above, according to the second embodiment, by switching the object size estimation method according to the object occlusion state, the object size can be stably identified even if the object is occluded at high probability during the sport is played.

### Other Embodiments

The invention may be applied to a system consisting of multiple devices or to a device consisting of a single device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-197587, filed Nov. 21, 2023 which is hereby incorporated by reference herein in its entirety.

What is claimed is:

1. An image processing apparatus comprising one or more processors and/or circuitry which function as:
a selection unit that selects an object to be detected;
an acquisition unit that acquires an image;
a detection unit that detects the object selected by the selection unit from the image; and
a determination unit that determines a size of the object detected by the detection unit in the image,
wherein the determination unit changes part of the object to be determined as the size of the object in the image in accordance with a shape of the object.

2. The image processing apparatus according to claim 1, wherein
the object includes a first object having an inflated oval shape, and
in a case where the first object is detected by the detection unit, the determination unit determines a length of a minor axis of the first object in the image as the part determined to be the size of the first object.

3. The image processing apparatus according to claim 1, wherein
the object includes a second object having a disk shape, and
in a case where the second object is detected by the detection unit, the determination unit determines a length of a major axis of the second object in the image as the part determined to be the size of the second object.

4. The image processing apparatus according to claim 1, wherein
the object includes a third object having a spherical shape, and
in a case where the third object is detected by the detection unit, the determination unit determines a length of diameter of the third object in the image as the size of the third object.

5. The image processing apparatus according to claim 1, wherein
the selection unit selects a sport and an object associated in advance to the selected sport, and
in a case where the sport selected by the selection unit is a predetermined sport in which a probability of the object being occluded by another object is high, the determination unit determines whether the object detected by the detection unit is occluded, and changes a method for determining the size of the object in the image in a case where it is determined that the object is occluded and in a case where it is determined that the object is not occluded.

6. The image processing apparatus according to claim 5, wherein
the object includes a first object having an inflated oval shape and associated to the sport in which a probability of the object being occluded by another object is high, and
in a case where the first object is detected by the detection unit, the determination unit
determines a size of the first object based on lengths of sides of a rectangular region representing an unoccluded area of the first object in the image determined as the part in a case where it is determined that the first object is occluded, and
determines a length of a minor axis of the first object in the image determined as the part as the size of the first object in a case where it is determined that the first object is not occluded.

7. The image processing apparatus according to claim 5, wherein
the object includes a second object having a disk shape and associated to the sport in which a probability of the object being occluded by another object is high, and
in a case where the second object is detected by the detection unit, the determination unit
determines a size of the second object based on lengths of sides of a rectangular region representing an unoccluded area of the second object in the image determined as the part in a case where it is determined that the second object is occluded, and
determines a length of a major axis of the second object in the image determined as the part as the size of the second object in a case where it is determined that the second object is not occluded.

8. The image processing apparatus according to claim 5, wherein
the object includes a third object having a spherical shape and associated to the sport in which a probability of the object being occluded by another object is high, and
in a case where the third object is detected by the detection unit, the determination unit
determines a length of a long side of a rectangular region representing an unoccluded area of the third object in the image determined as the part as a size of the third object in a case where it is determined that the third object is occluded, and
determines the size of the third object based on lengths of short and long sides of a rectangular region representing an unoccluded area of the third object in the image determined as the part in a case where it is determined that the first object is not occluded.

9. The image processing apparatus according to claim 1, wherein the detection unit further obtains a position of the detected object in the image, and
the one or more processors and/or circuitry which further function as:
a subject detection unit that detects a predetermined subject included in the image and obtains the position and size of the detected subject in the image; and
a decision unit that decides, in a case where a plurality of the subjects are detected by the subject detection unit, a main subject from the plurality of subjects based on the position and size of each of the subjects in the image and the position and size of the object in the image.

10. The image processing apparatus according to claim 9, wherein the decision unit estimates a distance in a depth direction at which the plurality of subjects and the object are present based on the size of each of the subjects in the image and the size of the object in the image, and decides a main subject based on the estimated distance, the position of each of the subjects in the image, and the position of the object in the image.

11. An image capturing apparatus comprising:
an image processing apparatus comprising one or more processors and/or circuitry which function as:
a selection unit that selects an object to be detected;
an acquisition unit that acquires an image;
a detection unit that detects the object selected by the selection unit from the image; and
a determination unit that determines a size of the object detected by the detection unit in the image; and
an image sensor that captures an image,
wherein the determination unit changes part of the object to be determined as the size of the object in the image in accordance with a shape of the object, and
the acquisition unit acquires the image captured by the image sensor.

12. An image capturing apparatus comprising:
an image processing apparatus comprising one or more processors and/or circuitry which function as:
a selection unit that selects an object to be detected;
an acquisition unit that acquires an image;
a detection unit that detects the object selected by the selection unit from the image and a position of the detected object in the image;
a determination unit that determines a size of the object detected by the detection unit in the image; and
a subject detection unit that detects a predetermined subject included in the image and obtains the position and size of the detected subject in the image, and
a decision unit that decides, in a case where a plurality of the subjects are detected by the subject detection unit, a main subject from the plurality of subjects based on the position and size of each of the subjects in the image and the position and size of the object in the image; and
a focus control unit that performs focus control so as to focus on the main subject decided by the decision unit,
wherein the determination unit changes part of the object to be determined as the size of the object in the image in accordance with a shape of the object.

13. An object size determination method comprising:
selecting an object to be detected;
acquiring an image;
detecting the selected object from the image; and
determining a size of the detected object in the image,
wherein part of the object to be determined as the size of the object in the image is changed in accordance with a shape of the object.

14. A non-transitory computer-readable storage medium, the storage medium storing a program that is executable by the computer, wherein the program includes program code for causing the computer to function as an image processing apparatus comprising:
a selection unit that selects an object to be detected;
an acquisition unit that acquires an image;
a detection unit that detects the object selected by the selection unit from the image; and
a determination unit that determines a size of the object detected by the detection unit in the image,
wherein the determination unit changes part of the object to be determined as the size of the object in the image in accordance with a shape of the object.
